(19) United States
(12) Patent Application Publication
(10) Pub. No.: US 2019/0102295 A1
(43) Pub. Date: Apr. 4, 2019

(54) METHOD AND APPARATUS FOR ADAPTIVELY SELECTING DATA TRANSFER PROCESSES FOR SINGLE-PRODUCER-SINGLE-CONSUMER AND WIDELY SHARED CACHE LINES

(71) Applicant: Intel Corporation, Santa Clara, CA (US)

(72) Inventors: Samantika S. Sury, Westford, MA (US); Robert G. Blankenship, Tacoma, WA (US); Simon C. Steely, JR., Hudson, NH (US); Yen-Cheng Liu, Portland, OR (US)

(21) Appl. No.: 15/721,121

(22) Filed: Sep. 29, 2017

(51) Int. Cl. G06F 12/084; G06F 12/0846; G06F 12/128; G06F 12/0811

(52) U.S. Cl. CPC G06F 12/084; G06F 12/0846; G06F 2212/283; G06F 12/0811; G06F 2212/621; G06F 12/128

(57) ABSTRACT

A method for adaptively performing a set of data transfer processes in a multi-core processor is described. The method may include receiving, by a shared cache from a first core cache, a first request for a cache line; determining, by the shared cache in response to receipt of the first request, whether the cache line is a widely-shared cache line or a single-producer-single-consumer cache line; and performing, by the first core cache and a second core cache, a three-hop data transfer process in response to determining that the cache line is a single-producer-single-consumer cache line, wherein the three-hop data transfer process transfers the cache line directly from the second core cache to the first core cache.

### FIELD OF INVENTION

The field of the invention relates generally to computer processor architectures. More specifically, the field of the invention relates to adaptively selecting data transfer processes for widely-shared cache lines and single-producer-single-consumer cache lines.

### BACKGROUND

Traditional multi-level cache systems for multi-core processors do not distinguish between cache lines (e.g., cache blocks) shared by many cores or threads (also known as widely-shared cache lines) and cache lines that are shared between just two cores or threads (also known as single-producer-single-consumer cache lines). Thus, widely-shared cache lines and single-producer-single-consumer cache lines are treated the same in these systems. In particular, a first request for both kinds of shared cache lines cause the processor to respond using a four-hop data transfer process. In this four-hop data transfer process, a modified cache line is in a first core cache, which is dedicated to a first core. When snooped in relation to an access request by a second core cache of a second core, the modified cache line gets allocated in a higher-level shared cache. By being allocated in the higher-level shared cache, the cache line may be accessed directly from the shared cache using a two-hop data transfer process and without the need to again transfer the cache line from the first core cache. For widely-shared cache lines that are shared by many cores or threads, allocating the cache line in a shared cache avoids costly transfers of the cache line to the shared cache.

Although the use of the four-hop data transfer process in conjunction with the two-hop data transfer process may provide efficiency gains for widely-shared cache lines, this efficiency improvement may not be shared by single-producer-single-consumer cache lines. Specifically, allocating space for a single-producer-single-consumer cache line in a higher-level shared cache, will pollute the shared cache as the single-producer-single-consumer cache line will not be further accessed from the shared cache. Further, the four-hop data transfer process requires multiple transfers of the cache line (e.g., from a first core cache to a shared cache and from the shared cache to a second core cache). These multiple transfers of the cache line are computationally expensive (e.g., a high number of used cycles) and, as noted above, cause pollution to the shared cache (e.g., wasted space in the shared cache). Accordingly, traditional multi-level cache systems for multi-core processors are inefficient in their treatment of single-producer-single-consumer cache lines as the lead to inefficient use of resources.

### BRIEF DESCRIPTION OF THE DRAWINGS

Embodiments of the present invention are illustrated by way of example and not limitation in the figures of the accompanying drawings, in which like references indicate similar elements and in which:

FIG. 1 shows a multi-level cache system within a processor according to one example embodiment.

FIG. 2 shows a four-hop data transfer process according to one example embodiment.

FIG. 3 shows a two-hop data transfer process according to one example embodiment.

FIG. 4 shows a three-hop data transfer process according to one example embodiment.

FIG. 5 presents a method for adaptively performing data transfer processes according to one example embodiment.

FIG. 6 shows a multi-level cache system within a processor according to one example embodiment.

FIG. 7 shows an example tag entry according to one example embodiment.

FIG. 8 is a block diagram of a processor that may have more than one core, may have an integrated memory controller, and may have integrated graphics according to example embodiment.

FIG. 9 shown a block diagram of a system according to example embodiment.

FIG. 10 is a block diagram of a first more specific exemplary system according to example embodiment.

FIG. 11 is a block diagram of a second more specific exemplary system according to example embodiment.

FIG. 12 is a block diagram of a System-on-a-Chip (SoC) according to example embodiment.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

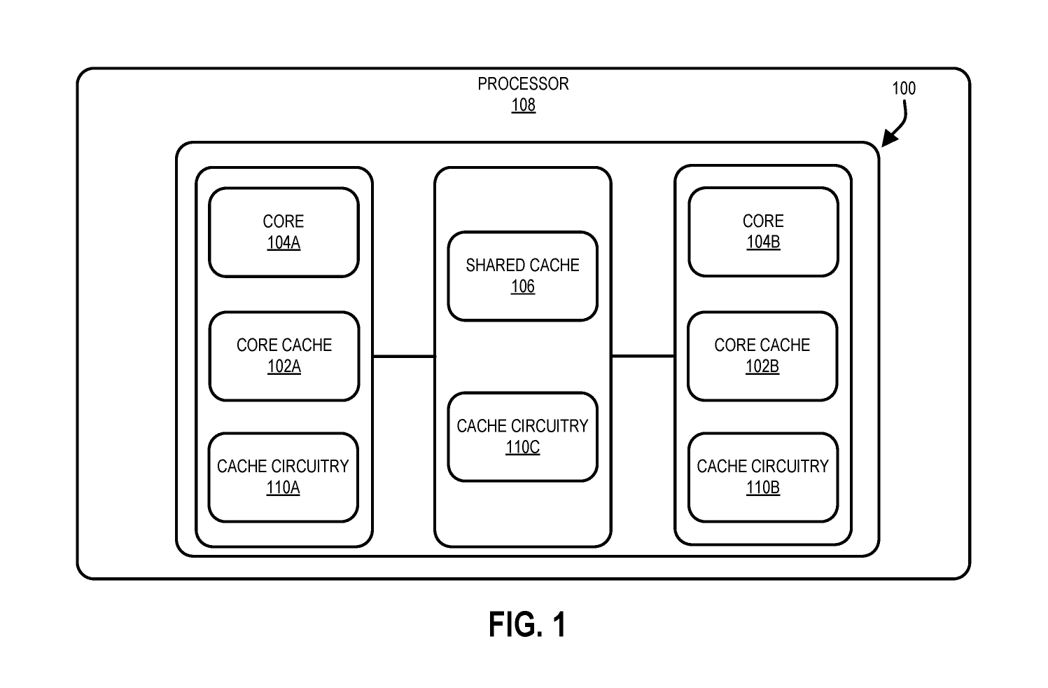

FIG. 1 shows a multi-level cache system 100 within a processor 108 according to one embodiment. As shown, the multi-level cache system 100 includes core cache 102A associated with core 104A and core cache 102B associated with core 104B. The core cache 102A and the core cache 102B may be private, dedicated, and/or local to the cores 104A and 104B, respectively, and may operate at a lower-level in the multi-level cache system 100 than the shared cache 106. For example, the core cache 102A and the core cache 102B may be level-two (L2) caches and the shared cache 106 may be a level-one (L1) cache or a last-level cache (LLC) within the processor 108 comprising the core 104A and the core 104B.

As used herein, a “cache” or “cache memory”, including the core cache 102A, the core cache 102B, and the shared cache 106, may be defined as a hardware or software component that stores cache lines for use by a processor/core (e.g., the core 104A, the core 104B, and/or the processor 108). A processor/core may operate on a cache line within a cache using any operation/instruction (e.g., performing arithmetic or logic functions). A cache line may be a basic unit of storage in a cache and may generally referred to as a block or a sector of memory (e.g., a cache) that may be managed as a unit for coherence purposes. In some embodiments, a cache line within a cache may be between 16-256 bytes. A cache line may be stored in cache memory (e.g., in a L3, L2, and/or L1 cache), system memory, or combinations thereof. A cache may be shared by multiple cores of a multi-processor, and consequently threads executing on each of these cores, or local/dedicated/private to single core of a processor (e.g., not shared). Cache memory may refer to a memory buffer inserted between one or more processors and a bus to, for example, store/hold currently active copies of cache lines, (e.g., blocks from system (main) memory).

In some embodiments, the core cache 102A and the core cache 102B may each be (1) inclusive relative to the shared cache 106 (e.g., all cache lines in one or both of the core caches 102A and 102B are also in the shared cache 106), (2) exclusive relative to the shared cache 106 (e.g., cache lines in one or both of the core caches 102A and 102B are not in the shared cache 106), or (3) the core caches 102A and 102B are not strictly inclusive or exclusive relative to the shared cache 106. In several of the example embodiments described below, the core caches 102A and 102B may be neither strictly inclusive nor strictly exclusive relative to the shared cache 106.

In some embodiments, one or more of the core caches 102A and 102B may include cache lines that are widely-shared between cores 104 in the processor 108. A widely-shared cache line is a cache line that is shared amongst many cores 104 or threads. For example, a cache-line may be considered a widely-shared cache line when the number of cores 104 that share the cache line for reading and/or writing is equal to or exceeds a widely-shared threshold. For instance, the widely-shared threshold may be equal to three (e.g., three cores 104). When the widely-shared threshold is three, a cache line that is shared by two or less cores 104 is not considered a widely-shared cache line while a cache line that is shared by three or more cores 104 is considered a widely-shared cache line. Although the widely-shared threshold is described as being three, in other embodiments the widely-shared threshold may be any number greater than two (e.g., 3-10).

In some embodiments, one or more of the core caches 102A and 102B may include cache lines that are single-producer-single-consumer. A single-producer-single-consumer cache line is shared by two cores (e.g., a producer core and a consumer core). In some embodiments, a single-producer-single-consumer cache line is by definition not a widely-shared cache line. Conversely, a widely-shared cache line is by definition not a single-producer-single-consumer cache line. Accordingly, the widely-shared threshold may be used for also determining whether a cache line is a single-producer-single-consumer cache line in addition to determining whether a cache line is a widely-shared cache line (e.g., a cache line that is shared by a number of cores that is less than the widely-shared threshold is considered a single-producer-single-consumer cache line).

As used herein, the processor 108 is a single computing component with two or more independent cores 104 (e.g., processing units), which are physical or logical units that read and execute commands and/or instructions. For example, each core 104 in the processor 108 may execute a sequence of instructions within a separate corresponding thread of a process. Although shown as including two cores 104 (e.g., the core 104A and the core 104B), the processor 108 may include any number of cores 104 (e.g., two or more cores 104). Each core 104 in the processor 108 may have their own dedicated, private, or local cache and may share one or more caches with other cores 104 in the processor 108. For example, the core cache 102A may be dedicated to the core 104A, the core cache 102B may be dedicated to the core 104B, and the shared cache 106 may be shared amongst the cores 104A and 104B. In this fashion, the shared cache 106 may store cache lines that are accessible by the core 104A and the core 104B via data transfer processes as will be described in further detail below. Although described as the cores 104 or the cores caches 102 accessing or sharing cache lines, it is understood that processes or threads being executed by the cores 104 may similarly access or share the cache lines.

In some embodiments, the core caches 102 and the shared cache 106 may each be associated with cache circuitry 110. For example, as shown in FIG. 1, the core cache 102A may be associated with the cache circuitry 110A, the core cache 102B may be associated with the cache circuitry 110B, and the shared cache 106 may be associated with the cache circuitry 110C. Although shown as being external or outside the core caches 102 and the shared cached 106, in some embodiments the cache circuitry 110 may be part of or within the corresponding cache structure (e.g., the cache circuitry 110A is part of the core cache 102A, the cache circuitry 110B is part of the core cache 102B, and the cache circuitry 110C is part of the shared cache 106). Each of the cache circuitries 110 may include logic structures that assist the core caches 102 and/or the shared cache 106 to perform one or more operations, including the data transfer processes and methods described herein.

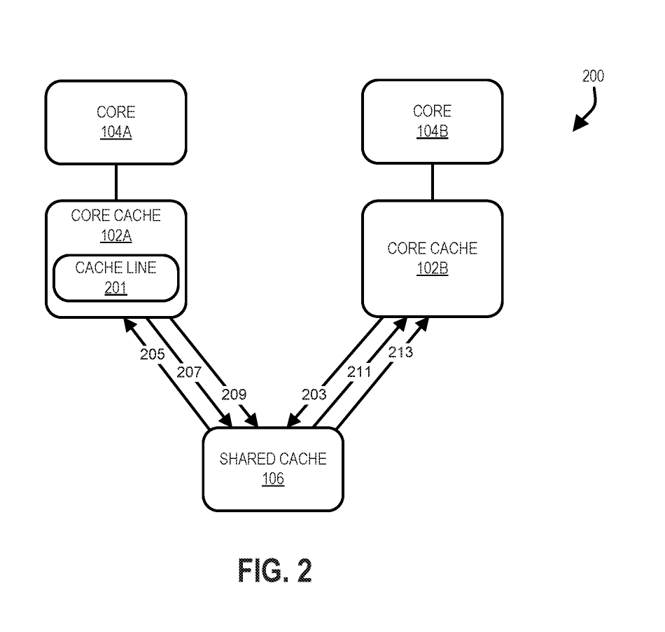

FIG. 2 shows a four-hop data transfer process 200 according to one example embodiment for sharing cache lines between the core cache 102A and the core cache 102B and consequently between the core 104A and the core 104B. In some embodiments, the four-hop data transfer process 200 may be performed in response to a cache miss in the core cache 102B. A cache miss occurs in the core cache 102B based on the cache line 201 missing from the core cache 102B (e.g., the cache line 201 is not allocated or located within the core cache 102B). The cache miss may be an instruction read miss, a data read miss, or a data write miss. In response to the cache miss, the core cache 102B may transmit 203 a request for the cache line 201 to the shared cache 106. In this example, the cache line 201 is not present in the shared cache 106, but the cache line 201 is present in the core cache 102A. In one embodiment, the shared cache 106 may determine that the cache line 201 is present in the core cache 102A based on a tag directory in or associated with the shared cache 106. The tag directory may include tag entries which track the location of cache lines within the multi-level cache system 100. For example, the tag directory may indicate that the cache line 201 is modified within the core cache 102A.

In the example embodiment of FIG. 2, the core cache 102A may be monitoring or snooping 205 a bus or communication channel between the core cache 102B and the shared cache 106 for all bus transactions. In one embodiment, the snooping 205 may be performed by a cache monitor of the core cache 102A. In response to snooping 205 the request 203 for the cache line 201, the core cache 102A may determine that the cache line 201 is located within the core cache 102A. In response to the determination that the cache line 201 is located within the core cache 102A, the core cache 102A may send 207 a response to the shared cache 106. The response may be responsive to the request for the cache line 201 and may indicate that the core cache 102A is currently storing the cache line 201 being requested by the core cache 102B. Concurrent with the transmission 207 of the response, the core cache 102A may send 209 the cache line 201 to the shared cache 106.

Upon receipt of the cache line 201 from the core cache 102A or responsive to the response, the shared cache 106 may allocate storage space for the cache line 201 in the shared cache 106. Accordingly, the cache line 201 may now be located in the shared cache 106 such that the shared cache 106 may transmit 211 the cache line 201 to the core cache 102B. In one embodiment, the cache line 201 may be transmitted 211 to the core cache 102B along with a transmission 213 of a completion message. The completion message indicates that the request for the cache line 201 was successfully completed (e.g., the cache line 201 was successfully transferred to the core cache 102B for access by the core 104B). The shared cache 106 maintains coherence for requests (e.g., via a tag directory) by allowing just one request per cache line (e.g., per cache address) to be processed at a time. The completion message lets the shared cache 106 know that a coherent transaction is completed so that another request to the same cache line (e.g., the same cache address) can be processed.

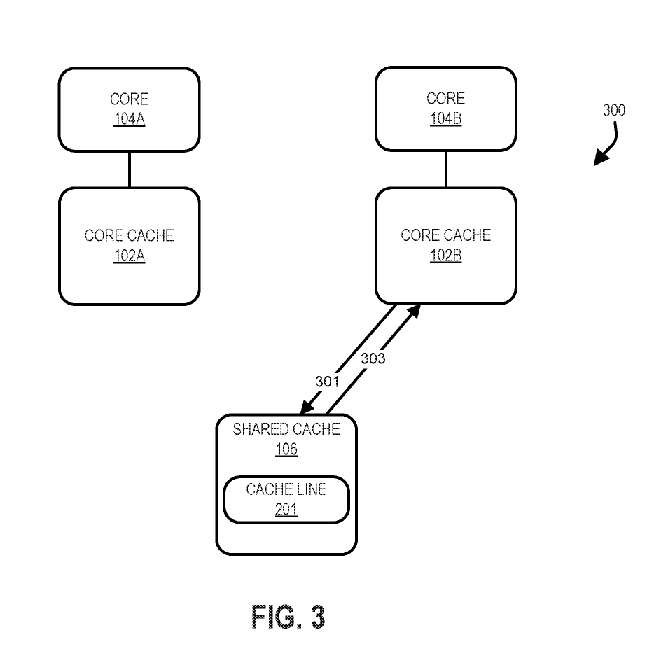

The above described four-hop data transfer process 200 may incur significant overhead. In particular, each arrow shown in FIG. 2 may take on average twenty cycles to complete such that a baseline latency of at least eighty cycles may be incurred, which is on the order of accessing data direct from main memory. This computational expense is principally caused by the multiple transmissions of the cache line 201 (e.g., from the core cache 102A to the shared cache 106 and from the shared cache 106 to the core cache 102B). However, the overhead incurred through this four-hop data transfer process 200 may be offset when performed as a first access by cores 104 of a widely-used cache line. In particular, the four-hop data transfer process 200 may allocate a widely-shared cache line in the shared cache 106 for access by multiple cores 104. Subsequent accesses to the widely-shared cache line may thereafter invoke a computationally inexpensive two-hop data transfer process. A two-hop data transfer process 300, according to one embodiment, is shown in FIG. 3.

As shown in FIG. 3, the cache line 201 is present in the shared cache 106, which is shared between the core caches 102A and 102B. As noted above, the cache line 201 may have been allocated in the shared cache 106 through use of the four-hop data transfer process 200. Similar to the four-hop data transfer process 200, the two-hop data transfer process 300 may be performed in response to a cache miss in the core cache 102B for the cache line 201. Upon detection of the cache miss, the core cache 102B may transmit 301 a request for the cache line 201 to the shared cache 106. Since the cache line 201 is present in the shared cache 106, upon receiving the request from the core cache 102B for the cache line 201, the shared cache 106 may respond 303 to the core cache 102B with the cache line 201. In comparison to the four-hop data transfer process 200, the two-hop data transfer process 300 includes less steps or hops, including less transfers of the cache line 201 between caches. Thus, for widely-shared cache lines, which will potentially be accessed by numerous cores 104 (e.g., three or more cores) and subject to numerous requests (e.g., two or more requests), allocating the widely-shared cache line in the shared cache 106 during a first access request via the four-hop data transfer process 200 and using the two-hop data transfer process 300 for subsequent access requests, may yield overhead savings (e.g., reduced cycles) over time (e.g., as the number of access requests for the widely-shared cache line increases).

However, the above described overhead savings caused by the joint use of the four-hop data transfer process 200 and the two-hop data transfer process 300 may not be realized by single-producer-single-consumer cache lines. In particular, a single-producer-single-consumer cache line is accessed by only a few cores 104 (e.g., accessed by two cores 104). Thus, allocating a single-producer-single-consumer cache line in the shared cache 106 via the four-hop data transfer process 200 may never yield an efficiency improvement (e.g., reduced number of cycles used) as subsequent access requests that are processed through the two-hop data transfer process 300 will never be performed. Further, allocating space in the shared cache 106 for a single-producer-single-consumer cache line that will not be highly accessed results in pollution of the shared cache 106. To address efficiency issues (both in terms of wasted cycles and space in the shared cache 106), a different data transfer process may be used for single-producer-single-consumer cache lines.

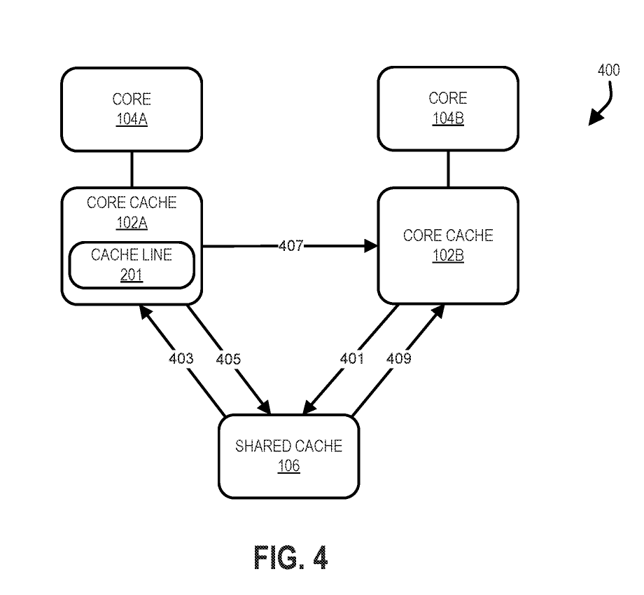

FIG. 4 shows an example embodiment of a three-hop data transfer 400 that may be used for single-producer-single-consumer cache lines. In this example, the cache line 201 is present in the core cache 102A. Similar to the four-hop data transfer process 200 and the two-hop data transfer process 300, the three-hop data transfer process 400 may be performed in response to a cache miss in the core cache 102B for the cache line 201. Upon detection of the cache miss, the core cache 102B may transmit 401 a request for the cache line 201 to the shared cache 106. The request may be received by the shared cache 106 and may be snooped 403 by the core cache 102A. In response to snooping 403 the request for the cache line 201, the core cache 102A may transmit 405 to the shared cache 106 a response to the request, which indicates that the cache line 201 is present in the core cache 102A and/or the core cache 102A will directly transmit 407 the cache line 201 to the core cache 102B. In one embodiment, the transmission 407 of the cache line 201 to the core cache 102B may be performed concurrently with transmission 405 of the response to the shared cache 106. In one embodiment, the shared cache 106 may transmit 409 a completion message to the core cache 102B. The completion message indicates that the request for the cache line 201 was successfully completed (e.g., the cache line 201 was successfully transferred to the core cache 102B). Since the shared cache 106 may process a single access request to a cache line at a time, the completion message signals that the request was completed and another request can be processed for the same cache line.

As shown in FIG. 4 and described above, the three-hop data transfer process 400 does not allocate the cache line 201 in the shared cache 106 and accordingly the shared cache 106 does not directly transfer the cache line 201 from the shared cache 106. Instead, the core cache 102A transmits the cache line 201 directly to the core cache 102B. This avoids both a computational expensive additional transmission of the cache line 201 (e.g., from the core cache 102A to the shared cache 106) and allocated space in the shared cache 106 for the cache line 201.

In many systems, data transfer policies follow the four-hop data transfer process 200 by default when transferring cache lines from cache-to-cache (e.g., from the core cache 102A to the core cache 102B), which may also be viewed as transferring cache lines from core-to-core (e.g., from the core 104A to the core 104B). This approach results in all requested cache lines, including single-producer-single-consumer cache lines, being allocated in the shared cache 106 as there is no knowledge of when a cache line may be later used/accessed by cores via the two-hop data transfer process 300 (e.g., the cache line is widely-shared and may be useful for barriers, locks and other multi-consumer data sharing patterns). However, as noted above, single-producer-single-consumer cache lines may waste computational cycles and space in the shared cache 106 when using the four-hop data transfer process 200 since these cache lines are not shared by many cores 104 (e.g., shared by just two cores 104).

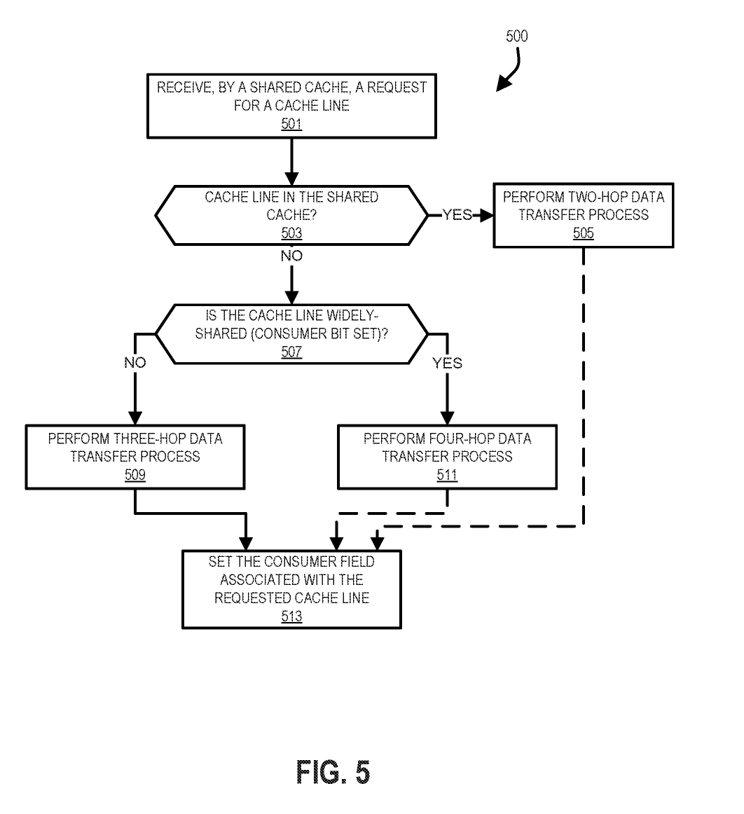

To address the differences with widely-shared cache lines and single-producer-single-consumer cache lines, FIG. 5 presents a method 500 for adaptively performing data transfer processes according to one example embodiment. The method 500 dynamically distinguishes between widely-shared cache lines and single-producer-single-consumer cache lines such that appropriate data transfer processes may be performed for each type of cache line. In particular, as will be described in additional detail below, the method 500 initially assumes for a first request for a cache line that the cache line is a single-produce-single-consumer cache line. Based on this assumption, the three-hop data transfer process 400 is used for fulfilling the request for the cache line (e.g., the cache line is transferred directly between core caches 102 and is not allocated in the shared cache 106). However, after subsequent requests for the cache line, the method 500 may determine that the cache line is widely-shared. When the cache line is determined to be widely-shared, the method 500 may use the four-hop data transfer process 200 to fulfill the current request for the cache line by allocating the cache line into the shared cache 106. Thereafter, the two-hop data transfer process 300 may be used for subsequent requests for the cache line by transmitting the cache line directly from the shared cache 106 to the requesting core cache 102. The method 500 is described in greater detail by way of example below.

Although shown in a particular order, the operations of the method 500 may be performed in a different order. For example, two or more operations of the method 500 may be performed in partially or in entirely overlapping time periods. Further, in some embodiments, the method 500 may include additional operations not shown or described herein. Accordingly, the method 500 is intended to be illustrative rather than restrictive.

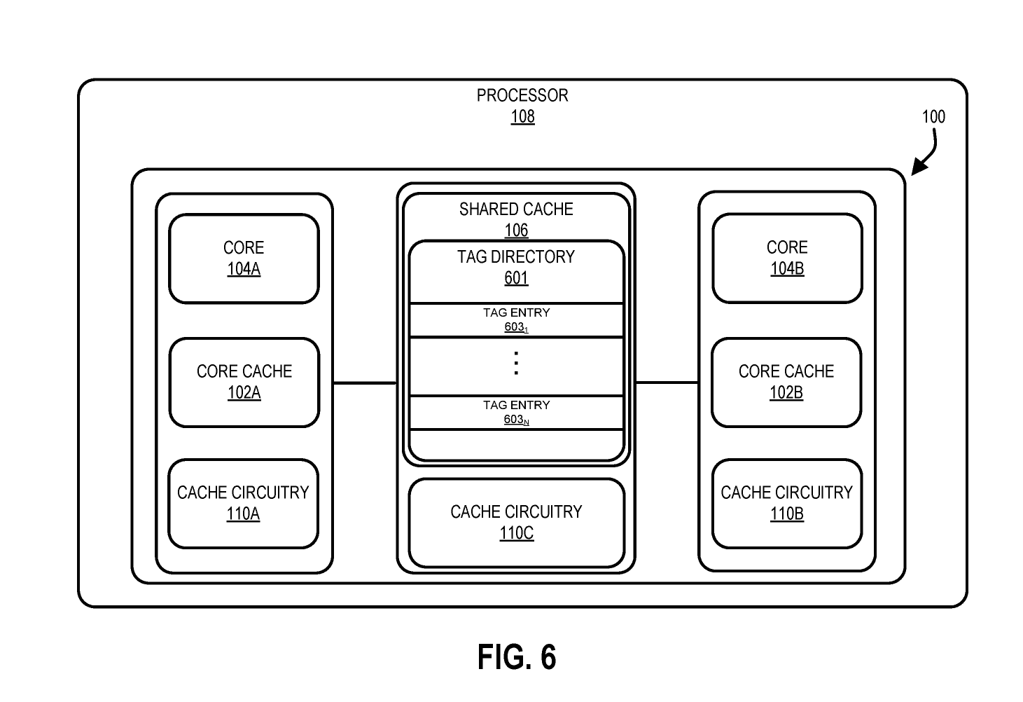

Each operation of the method 500 may be performed by one or more elements of the multi-level cache system 100. FIG. 6 shows the multi-level cache system 100 within a processor 108 according to one embodiment. The method 500 will be described in relation to the multi-level cache system 100 shown in FIG. 6. For example, one or more of the operations of the method 500 may be performed by one or more of the core cache 102A, the core cache 102B, the shared cache 106, the core 104A, and the core 104B.

The method 500 may commence at operation 501 with receipt by the shared cache 106 of a request from the core cache 102B for a cache line. For example, as shown in FIG. 4, the core cache 102B may transmit a request 401 for the cache line 201 to the shared cache 106. The request 401 may have been precipitated by a cache miss in the core cache 102B based on the cache line 201 missing from the core cache 102B. The cache miss may be an instruction read miss, a data read miss, or a data write miss.

In one embodiment, the shared cache 106 may include or otherwise have access to a tag directory 601 (also known as a snoop filter). Each cache line request, snoop, and response (separate from the actual transmission of cache lines) in the processor 108 may pass-through or otherwise be processed by the tag directory 601. The tag directory 601 includes one or more tag entries 603 (e.g., tag entries 603₁-603_{N}, where N is greater than or equal to two). Each tag entry 603 corresponds to unique cache lines in the core cache 102A, the core cache 102B, and the shared cache 106. For example, if a cache line is located in both the core cache 102A and the shared cache 106, the tag directory 601 includes a single tag entry 603 for this cache line.

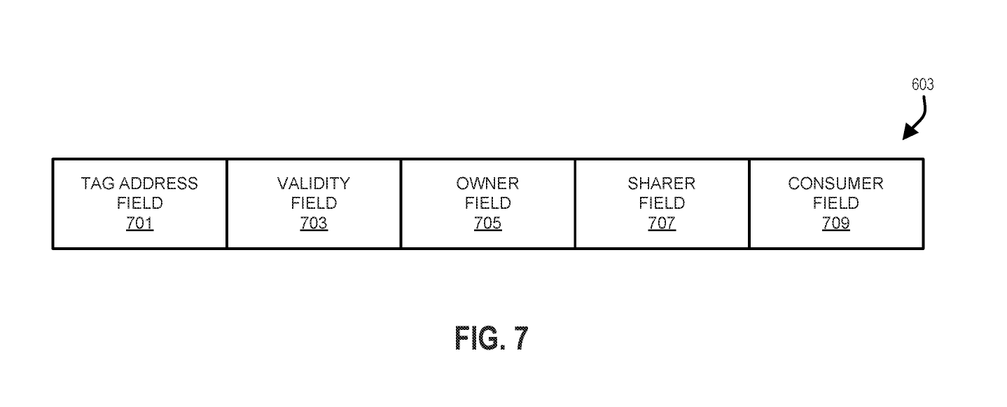

FIG. 7 shows an example tag entry 603 according to one embodiment. The tag entry 603 includes a tag address field 701, a validity field 703, an owner field 705, a sharer field 707, and a consumer field 709. Although shown with the fields 701, 703, 705, 707, and 709, in other embodiments tag entries 603 may include additional fields. In one embodiment, as will be described in greater detail below, the consumer field 709 may be used for determining whether a corresponding cache line is a widely-shared cache line or a single-producer-single-consumer cache line.

Upon receiving the request for the cache line 201, the tag directory 601 may determine at operation 503 whether the requested cache line is located in the shared cache 106 or in another cache (e.g., the core cache 102A). Upon determining that the cache line is in the shared cache 106, operation 505 may perform the two-hop data transfer process 300 to deliver the cache line, which is located in the shared cache 106, to the core cache 102B.

Otherwise, when operation 503 determines that the cache line is located outside the shared cache 106 (e.g., the requested cache line is in the core cache 102A), the method 500 moves to operation 507 to determine whether the requested cache line is a widely shared cache line or a single-producer-single-producer cache line. In one embodiment, the determination at operation 507 may be performed by checking the consumer field 709 of a tag entry 603 in the tag directory 601 associated with the requested cache line. The consumer field 709 indicates whether the requested cache line is a widely-shared cache line or a single-producer-single-producer cache line. In one embodiment, the consumer field 709 is a single bit and when set or toggled on (e.g., the consumer field 709 has a value of one), a request for the cache line was previously processed by the tag directory 601 and the cache line is considered a widely-shared cache line. Otherwise, when the consumer field 709 is not set or is toggled off (e.g., the consumer field 709 has a value of zero), a request for the cache line was not previously processed by the tag directory 601 and the cache line is considered a single-producer-single-consumer cache line.

Although described as the consumer field 709 being a single bit, in other embodiments the consumer field 709 may be comprised of more than one bit (e.g., two, three, or four bits). In these embodiments, an associated cache line may be determined to be a widely-shared cache line when the consumer field 709 is greater than or equal to a widely-shared threshold (e.g., the widely-shared threshold may be ten). Otherwise, when the consumer field 709 is less than the widely-shared threshold, the associated cache line is determined to be a single-producer-single-consumer cache line.

In the description that follows, the method 500 will be described in relation to the consumer field 709 being the primary source of input when determining at operation 507 whether an associated cache line is widely-shared or single-producer-single-consumer. However, it is understood that the method 500 may utilize any technique or set of inputs to determine whether a cache line is a widely-shared cache line or a single-producer-single-consumer cache line.

Upon determining at operation 507 that the requested cache line is single-producer-single-consumer (e.g., the consumer field 709 for the requested cache line is not set/toggled or the consumer field 709 is less than a widely-shared threshold), the method 500 may move to operation 509 to perform the three-hop data transfer process 400 for the requested cache line. The three-hop data transfer process 400 transfers the requested cache line directly from one core cache 102 to another core cache 102 (e.g., the core cache 102A to the core cache 102B and without allocating space in the shared cache 106 for the requested cache line.

Conversely, upon determining at operation 507 that the requested cache line is widely-shared (e.g., the consumer field 709 for the requested cache line is set/toggled or the consumer field 709 is greater than or equal to the widely-shared threshold), the method 500 may move to operation 511 to perform the four-hop data transfer process 200 for the requested cache line. The four-hop data transfer process 200 transfers the requested cache line from a core cache 102 to the shared cache 106 and thereafter from the shared cache 106 to another core cache 102 (e.g., from the core cache 102A to the shared cache 106 and then to the core cache 102B). In this fashion, the requested cache line is allocated space in the shared cache 106 such that future requests processed by the shared cache 106 for the requested cache line, may use the two-hop data transfer process 300.

After performing the three-hop data transfer process 400 at operation 509, the method 500 may move to operation 513. At operation 513, the consumer field 709 of the tag entry 603 corresponding to the requested cache line may be set or toggled. For example, the consumer field 709 may be changed from a current value of zero to a new value of one. By setting or toggling the consumer field 709 associated with the requested cache line, the method 500 indicates in the tag directory 601 that the requested cache line was previously requested. Consequently, for a subsequent request for the requested cache line, the method 500 may determine based on the consumer field 709, which has been set/toggled, that the requested cache line is a widely-shared cache line that would benefit from allocating space in the shared cache 106 via the four-hop data transfer process 200.

As noted above, in some embodiments, the consumer field 709 may comprise a plurality of bits. In these embodiments, setting the consumer field 709 at operation 513 may include incrementing the consumer field 709. For example, when moving from operation 509 to operation 513, the consumer field 709 for the requested cache line may be incremented from zero to one. In some embodiments, after performing the four-hop data transfer process 200 at operation 511 or the two-hop data transfer process 300 at operation 505, the method 500 may move to operation 513 to increment the consumer field 709 for the requested cache line. In these embodiments, the widely-shared threshold may be used for determining whether the requested cache line is a widely-shared cache line or a single-producer-single-consumer cache line at operation 507.

In some embodiments, the consumer field 709 for a cache line may be reset or cleared (e.g., set to zero or untoggled) upon the cache line being evicted from shared cache 106 or invalidated. In some embodiments, the consumer field 709 may be reset or cleared in response to an ownership request for the cache line. In this embodiment, read requests for a cache line set or increment the consumer field 709 while ownership requests for the cache line reset or clear the consumer field 709 for the cache line. Accordingly, when (1) a read request for a cache line is received and the consumer field for the cache line is not set or is clear or (2) a request for ownership of the cache line is received, the three-hop data transfer process 400 may be used for the read request for the cache line. Otherwise the four-hop data transfer process 200 may be used for cache line.

Although described as the consumer field 709 being reset or cleared for a cache line when the cached is evicted or invalidated, in some embodiments a proactive detection or proactive setting of the consumer field 709 may also be performed. For example, when a cache line is snooped and this causes the cache line to be invalidated in a core cache 102 (e.g., in response to a read for ownership of the cache line), in some situations this would cause the consumer field 709 of the cache line to be reset or cleared. However, if it can be determined that multiple core caches 102 and/or cores 104 share the cache line (e.g., based on the sharer field 707 of a tag entry 603 for the cache line), the consumer field 709 may be set or incremented to indicate that the cache line is a widely-shared cache line. Accordingly, in some embodiments, the consumer field 709 is set, incremented, or not cleared/reset in response to an eviction or invalidation when it is determined that the cache line is a widely-shared cache line.

As described above, the method 500 provides a selective mechanism for performing data transfer processes based on characteristics of a requested cache line. In particular, the method 500 initially assumes that a requested cache line is a single-producer-single-consumer cache line and performs the three-hop data transfer process 400 for delivering the requested cache line to a requesting core cache 102 and/or core 104. However, upon determining based on one or more subsequent requests for the cache line that the cache line is a widely-shared cache line, the method 500 performs the four-hop data transfer process 200 for delivering the requested cache line to a requesting core cache 102 and/or core 104. The four-hop data transfer process 200 allows the requested cache line to be allocated to the shared cache 106 such that subsequent requests for the cache line may allow the shared cache 106 to directly transmit the requested cache line to a core cache 102 via the two-hop data transfer process 300. This adaptive selection of data transfer processes reduces (1) unnecessary processing cycles and (2) wasted space in the shared cache 106 (e.g., pollution of the shared cache 106).

In some applications, approximately 50% of cache lines have been shown to be single-producer-single-consumer cache lines while approximately 20% of cache lines are widely-shared cache lines. For these applications, strictly utilizing the four-hop data transfer process 400 for all cache lines will result in wasted processing cycles and pollution of shared caches (e.g., a L1 or LLC cache). In some simulations, applications have achieved an 8% performance benefit when using the adaptive method 500 in comparison to traditional solutions where the four-hop data transfer process 400 is used for all requested cache lines.

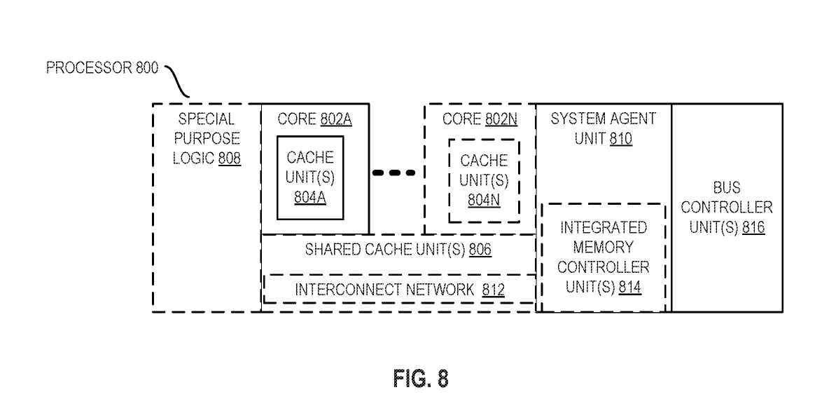

FIG. 8 is a block diagram of a processor 800 that may have more than one core, may have an integrated memory controller, and may have integrated graphics according to embodiments of the invention. The solid lined boxes in FIG. 8 illustrate a processor 800 with a single core 802A, a system agent 810, a set of one or more bus controller units 816, while the optional addition of the dashed lined boxes illustrates an alternative processor 800 with multiple cores 802A-N, a set of one or more integrated memory controller unit(s) 814 in the system agent unit 810, and special purpose logic 808. In one embodiment, the processor 800 may be the processor 108 and the core 104A may be one of the cores 802A-N and the core 104B may be another of the cores 802A-N.

Thus, different implementations of the processor 800 may include: 1) a CPU with the special purpose logic 808 being integrated graphics and/or scientific (throughput) logic (which may include one or more cores), and the cores 802A-N being one or more general purpose cores (e.g., general purpose in-order cores, general purpose out-of-order cores, a combination of the two); 2) a coprocessor with the cores 802A-N being a large number of special purpose cores intended primarily for graphics and/or scientific (throughput); and 3) a coprocessor with the cores 802A-N being a large number of general purpose in-order cores. Thus, the processor 800 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 800 may be a part of and/or may be implemented on one or more substrates using any of a number of process technologies, such as, for example, BiCMOS, CMOS, or NMOS.

The memory hierarchy includes one or more levels of cache within the cores, a set or one or more shared cache units 806, and external memory (not shown) coupled to the set of integrated memory controller units 814. The set of shared cache units 806 may include one or more mid-level caches, such as level 2 (L2), level 3 (L3), level 4 (L4), or other levels of cache, a last level cache (LLC), and/or combinations thereof. While in one embodiment a ring based interconnect unit 812 interconnects the integrated graphics logic 808 (integrated graphics logic 808 is an example of and is also referred to herein as special purpose logic), the set of shared cache units 806, and the system agent unit 810/integrated memory controller unit(s) 814, alternative embodiments may use any number of well-known techniques for interconnecting such units. In one embodiment, coherency is maintained between one or more cache units 806 and cores 802-A-N.

In some embodiments, one or more of the cores 802A-N are capable of multi-threading. The system agent 810 includes those components coordinating and operating cores 802A-N. The system agent unit 810 may include for example a power control unit (PCU) and a display unit. The PCU may be or include logic and components needed for regulating the power state of the cores 802A-N and the integrated graphics logic 808. The display unit is for driving one or more externally connected displays.

The cores 802A-N may be homogenous or heterogeneous in terms of architecture instruction set; that is, two or more of the cores 802A-N may be capable of execution the same instruction set, while others may be capable of executing only a subset of that instruction set or a different instruction set.

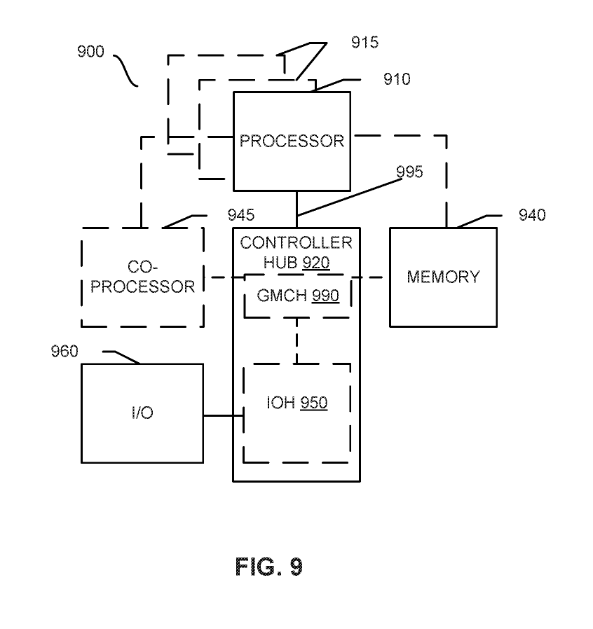

FIGS. 9-12 are block diagrams of exemplary computer architectures that may be used to implement the embodiments described herein. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 9, shown is a block diagram of a system 900 in accordance with one embodiment of the present invention. The system 900 may include one or more processors 910, 915, which are coupled to a controller hub 920. In one embodiment, the controller hub 920 includes a graphics memory controller hub (GMCH) 990 and an Input/Output Hub (IOH) 950 (which may be on separate chips); the GMCH 990 includes memory and graphics controllers to which are coupled memory 940 and a coprocessor 945; the IOH 950 couples input/output (I/O) devices 960 to the GMCH 990. Alternatively, one or both of the memory and graphics controllers are integrated within the processor (as described herein), the memory 940 and the coprocessor 945 are coupled directly to the processor 910, and the controller hub 920 in a single chip with the IOH 950.

The optional nature of additional processors 915 is denoted in FIG. 9 with broken lines. Each processor 910, 915 may include one or more of the processing cores described herein and may be some version of the processor 800. In one embodiment, the processor 108 may be one of the processors 910 and 915.

The memory 940 may be, for example, dynamic random-access memory (DRAM), phase change memory (PCM), or a combination of the two. For at least one embodiment, the controller hub 920 communicates with the processor(s) 910, 915 via a multi-drop bus, such as a frontside bus (FSB), point-to-point interface such as QuickPath Interconnect (QPI), or similar connection 995.

In one embodiment, the coprocessor 945 is a special-purpose processor, such as, for example, a high-throughput MIC processor, a network or communication processor, compression engine, graphics processor, GPGPU, embedded processor, or the like. In one embodiment, controller hub 920 may include an integrated graphics accelerator.

There can be a variety of differences between the physical resources 910, 915 in terms of a spectrum of metrics of merit including architectural, microarchitectural, thermal, power consumption characteristics, and the like.

In one embodiment, the processor 910 executes instructions that control data processing operations of a general type. Embedded within the instructions may be coprocessor instructions. The processor 910 recognizes these coprocessor instructions as being of a type that should be executed by the attached coprocessor 945. Accordingly, the processor 910 issues these coprocessor instructions (or control signals representing coprocessor instructions) on a coprocessor bus or other interconnect, to coprocessor 945. Coprocessor(s) 945 accept and execute the received coprocessor instructions.

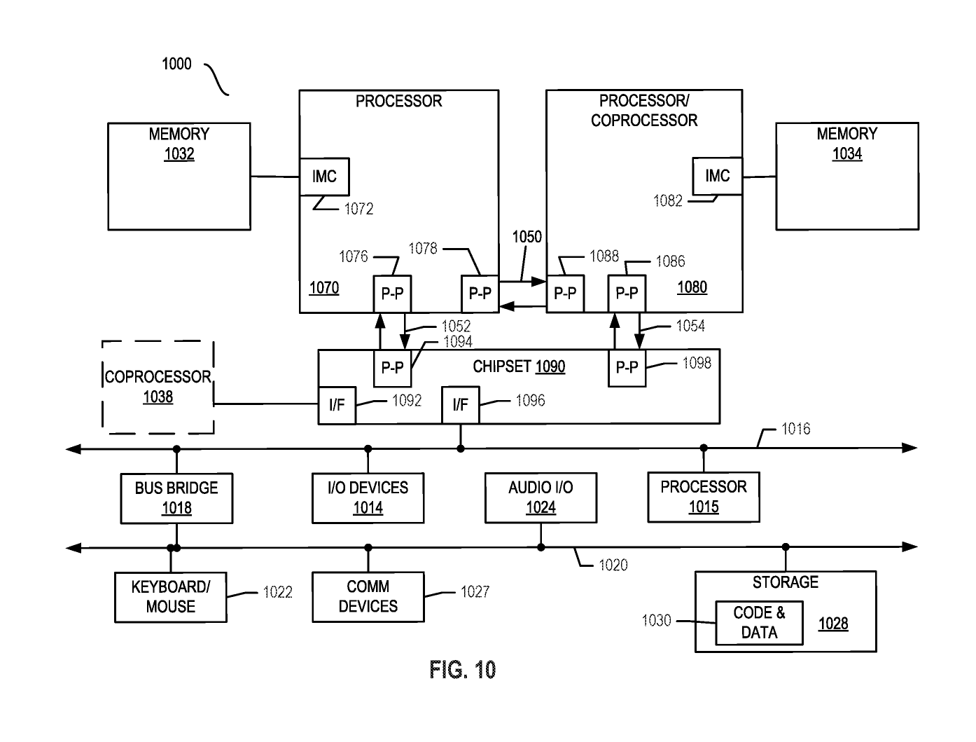

Referring now to FIG. 10, shown is a block diagram of a first more specific exemplary system 1000 in accordance with an embodiment of the present invention. As shown in FIG. 10, multiprocessor system 1000 is a point-to-point interconnect system, and includes a first processor 1070 and a second processor 1080 coupled via a point-to-point interconnect 1050. Each of processors 1070 and 1080 may be some version of the processor 800. In one embodiment of the invention, processors 1070 and 1080 are respectively processors 910 and 915, while coprocessor 1038 is coprocessor 945. In another embodiment, processors 1070 and 1080 are respectively processor 910 coprocessor 945.

Processors 1070 and 1080 are shown including integrated memory controller (IMC) units 1072 and 1082, respectively. Processor 1070 also includes as part of its bus controller units point-to-point (P-P) interfaces 1076 and 1078; similarly, second processor 1080 includes P-P interfaces 1086 and 1088. Processors 1070, 1080 may exchange information via a point-to-point (P-P) interface 1050 using P-P interface circuits 1078, 1088. As shown in FIG. 10, IMCs 1072 and 1082 couple the processors to respective memories, namely a memory 1032 and a memory 1034, which may be portions of main memory locally attached to the respective processors. In one embodiment, the processor 108 may be one of the processors 1070 and 1080.

Processors 1070, 1080 may each exchange information with a chipset 1090 via individual P-P interfaces 1052, 1054 using point to point interface circuits 1076, 1094, 1086, 1098. Chipset 1090 may optionally exchange information with the coprocessor 1038 via a high-performance interface 1092. In one embodiment, the coprocessor 1038 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 1090 may be coupled to a first bus 1016 via an interface 1096. In one embodiment, first bus 1016 may be a Peripheral Component Interconnect (PCI) bus, or a bus such as a PCI Express bus or another third generation I/O interconnect bus, although the scope of the present invention is not so limited.

As shown in FIG. 10, various I/O devices 1014 may be coupled to first bus 1016, along with a bus bridge 1018 which couples first bus 1016 to a second bus 1020. In one embodiment, one or more additional processor(s) 1015, such as coprocessors, high-throughput MIC processors, GPGPU's, accelerators (such as, e.g., graphics accelerators or digital signal processing (DSP) units), field programmable gate arrays, or any other processor, are coupled to first bus 1016. In one embodiment, second bus 1020 may be a low pin count (LPC) bus. Various devices may be coupled to a second bus 1020 including, for example, a keyboard and/or mouse 1022, communication devices 1027 and a storage unit 1028 such as a disk drive or other mass storage device which may include instructions/code and data 1030, in one embodiment. Further, an audio I/O 1024 may be coupled to the second bus 1020. Note that other architectures are possible. For example, instead of the point-to-point architecture of FIG. 10, a system may implement a multi-drop bus or other such architecture.

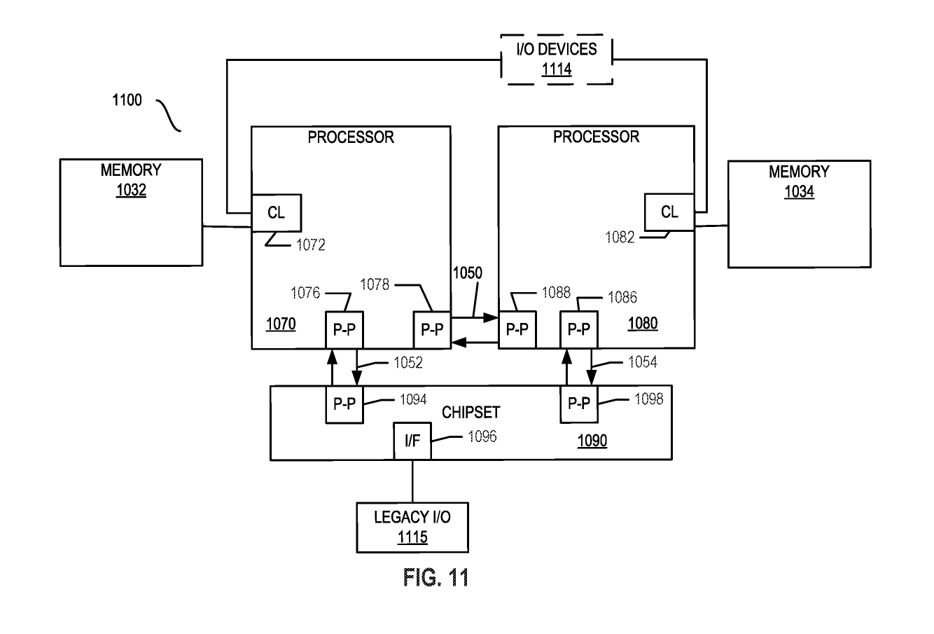

Referring now to FIG. 11, shown is a block diagram of a second more specific exemplary system 1100 in accordance with an embodiment of the present invention. Like elements in FIGS. 10 and 11 bear like reference numerals, and certain aspects of FIG. 10 have been omitted from FIG. 11 in order to avoid obscuring other aspects of FIG. 11.

FIG. 11 illustrates that the processors 1070, 1080 may include integrated memory and I/O control logic (“CL”) 1072 and 1082, respectively. Thus, the CL 1072, 1082 include integrated memory controller units and include I/O control logic. FIG. 11 illustrates that not only are the memories 1032, 1034 coupled to the CL 1072, 1082, but also that I/O devices 1114 are also coupled to the control logic 1072, 1082. Legacy I/O devices 1115 are coupled to the chipset 1090.

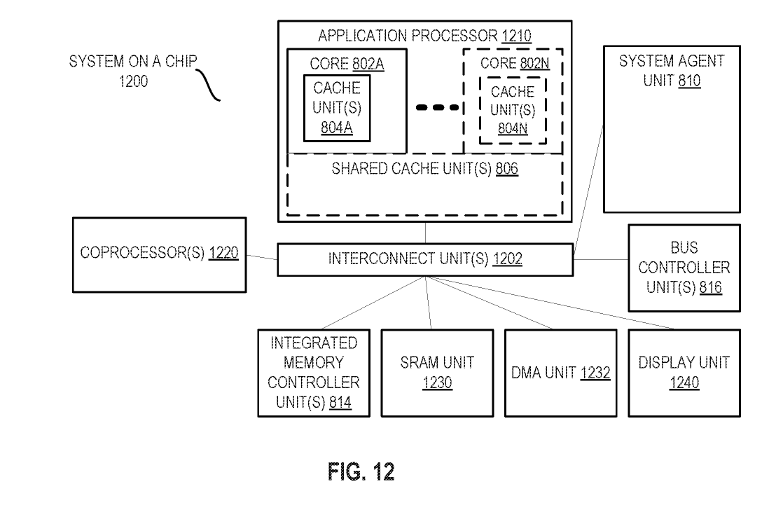

Referring now to FIG. 12, shown is a block diagram of a SoC 1200 in accordance with an embodiment of the present invention. Similar elements in FIG. 8 bear like reference numerals. Also, dashed lined boxes are optional features on more advanced SoCs. In FIG. 12, an interconnect unit(s) 1202 is coupled to: an application processor 1210 which includes a set of one or more cores 802A-N, which include cache units 804A-N, and shared cache unit(s) 806; a system agent unit 810; a bus controller unit(s) 816; an integrated memory controller unit(s) 814; a set or one or more coprocessors 1220 which may include integrated graphics logic, an image processor, an audio processor, and a video processor; an static random access memory (SRAM) unit 1230; a direct memory access (DMA) unit 1232; and a display unit 1240 for coupling to one or more external displays. In one embodiment, the coprocessor(s) 1220 include a special-purpose processor, such as, for example, a network or communication processor, compression engine, GPGPU, a high-throughput MIC processor, embedded processor, or the like. In one embodiment, the core cache 102A may be one of the cache units 804A-N, the core cache 102B may be one of the cache units 804A-N, and the shared cache 106 may be the shared cache unit 806.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code, such as code 1030 illustrated in FIG. 10, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high-level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

### FURTHER EXAMPLES

Example 1 provides a method for adaptively performing a set of data transfer processes in a multi-core processor, the method comprising: receiving, by a shared cache from a first core cache, a first request for a cache line; determining, by the shared cache in response to receipt of the first request, whether the cache line is a widely-shared cache line or a single-producer-single-consumer cache line; and performing, by the first core cache and a second core cache, a three-hop data transfer process in response to determining that the cache line is a single-producer-single-consumer cache line, wherein the three-hop data transfer process transfers the cache line directly from the second core cache to the first core cache.

Example 2 includes the substance of the exemplary method of Example 1, wherein determining whether the cache line is a widely-shared cache line or a single-producer-single-consumer cache line comprises: comparing a consumer field of a tag entry associated with the cache line to a widely-shared threshold.

Example 3 includes the substance of the exemplary method of Example 2, wherein the tag entry is stored in a tag directory of the shared cache, wherein the tag directory tracks locations of cache lines in the first core cache, the second core cache, and the shared cache.

Example 4 includes the substance of the exemplary method of any one of Examples 2 and 3, further comprising: incrementing the consumer field of the tag entry associated with the cache line in response to receiving the first request when the first request is a read request for the cache line.

Example 5 includes the substance of the exemplary method of any one of Examples 1-4, further comprising: performing a four-hop data transfer process in response to determining that the cache line is a widely shared cache line, wherein the four-hop data transfer process allocates the cache line in the shared cache from the second core cache and transmits the cache line from the shared cache to the first core cache line after the cache line is allocated in the shared cache.

Example 6 includes the substance of the exemplary method of Example 5, further comprising: evicting, following performance of the four-hop data transfer process, the cache line from the shared cache; and setting the consumer field of the tag entry associated with the cache line to zero in response to evicting the cache line from the shared cache.

Example 7 includes the substance of the exemplary method of any one of Examples 1-6, further comprising: determining, by the shared cache in response to receipt of the first request, which is a read request for the cache line, whether the cache line is allocated in the shared cache; and performing, by the shared cache and the first core cache, a two-hop data transfer process in response to determining that the cache line is allocated in the shared cache, wherein the two-hop data transfer process includes transferring the cache line from the shared cache to the first core cache.

Example 8 includes the substance of the exemplary method of any one of Examples 1-7, wherein the first core cache is dedicated to a first core in the multi-core processor, the second core cache is dedicated to a second core in the multi-core processor, and the shared cache is shared between the first core and the second core.

Example 9 includes the substance of the exemplary method of any one of Examples 1-8, wherein the shared cache is at a first level of a multi-level cache system and the first core cache and the second core cache are at a second level of the multi-level cache system.

Example 10 includes the substance of the exemplary method of any one of Examples 1-9, wherein the shared cache is a Level 1 cache of the multi-core processor and the first core cache and the second core cache are each Level 2 caches of the multi-core processor.

Example 11 provides a processor for managing a multi-level cache system, the processor comprising: a first core; a second core; a first core cache dedicated to the first core; a second core cache dedicated to the second core; a shared cache that is shared between the first core and the second core; and cache circuitry within one or more of the first core cache, the second core cache, and the shared core cache, the cache circuitry to: determine in response to receipt of a request for a cache line from the first core cache, whether the cache line is a widely-shared cache line or a single-producer-single-consumer cache line, and perform a three-hop data transfer process between the first core cache and the second core cache in response to determining that the cache line is a single-producer-single-consumer cache line, wherein the three-hop data transfer process transfers the cache line directly from the second core cache to the first core cache.

Example 12 includes the substance of the exemplary processor of Example 11, wherein the cache circuitry determines whether the cache line is a widely-shared cache line or a single-producer-single-consumer cache line by comparing a consumer field of a tag entry associated with the cache line to a widely-shared threshold.

Example 13 includes the substance of the exemplary processor of Example 12, wherein the tag entry is stored in a tag directory of the shared cache, wherein the tag directory tracks locations of cache lines in the first core cache, the second core cache, and the shared cache.

Example 14 includes the substance of the exemplary processor of any one of Examples 12 and 13, wherein the cache circuitry is further to: increment the consumer field of the tag entry associated with the cache line in response to receiving the request when the first request is a read request for the cache line.

Example 15 includes the substance of the exemplary processor of any one of Examples 11-14, wherein the cache circuitry is further to: perform a four-hop data transfer process in response to determining that the cache line is a widely shared cache line, wherein the four-hop data transfer process allocates the cache line in the shared cache from the second core cache and transmits the cache line from the shared cache to the first core cache line after the cache line is allocated in the shared cache.

Example 16 includes the substance of the exemplary processor of Example 15, wherein the cache circuitry is further to: evict, following performance of the four-hop data transfer process, the cache line from the shared cache; and set the consumer field of the tag entry associated with the cache line to zero in response to evicting the cache line from the shared cache.

Example 17includes the substance of the exemplary processor of any one of Examples 11-16, wherein the cache circuitry is further to: determine, in response to receipt of the first request, which is a read request for the cache line, whether the cache line is allocated in the shared cache; and perform a two-hop data transfer process between the shared cache and the first core cache in response to determining that the cache line is allocated in the shared cache, wherein the two-hop data transfer process includes transferring the cache line from the shared cache to the first core cache.

Example 18 includes the substance of the exemplary processor of any one of Examples 11-17, wherein the shared cache is at a first level of a multi-level cache system and the first core cache and the second core cache are at a second level of the multi-level cache system.

Example 19 includes the substance of the exemplary processor of any one of Examples 11-18, wherein the shared cache is at a first level of a multi-level cache system and the first core cache and the second core cache are at a second level of the multi-level cache system.

Example 20 includes the substance of the exemplary processor of any one of Examples 11-19, wherein the shared cache is a Level 1 cache of the processor and the first core cache and the second core cache are each Level 2 caches of the processor.

Example 21 provides a non-transitory machine-readable medium containing instructions that, when performed by a processor, cause the performance of operations comprising: receiving, by a shared cache from a first core cache, a first request for a cache line; determining, by the shared cache in response to receipt of the first request, whether the cache line is a widely-shared cache line or a single-producer-single-consumer cache line; and performing, by the first core cache and a second core cache, a three-hop data transfer process in response to determining that the cache line is a single-producer-single-consumer cache line, wherein the three-hop data transfer process transfers the cache line directly from the second core cache to the first core cache.

Example 22 includes the substance of the exemplary non-transitory machine-readable medium of Example 21, wherein determining whether the cache line is a widely-shared cache line or a single-producer-single-consumer cache line comprises: comparing a consumer field of a tag entry associated with the cache line to a widely-shared threshold.

Example 23 includes the substance of the exemplary non-transitory machine-readable medium of Example 22, wherein the operations further comprise: incrementing the consumer field of the tag entry associated with the cache line in response to receiving the first request when the first request is a read request for the cache line.

Example 24 includes the substance of the exemplary non-transitory machine-readable medium of any one of Examples 21-23, wherein the operations further comprise: performing a four-hop data transfer process in response to determining that the cache line is a widely shared cache line, wherein the four-hop data transfer process allocates the cache line in the shared cache from the second core cache and transmits the cache line from the shared cache to the first core cache line after the cache line is allocated in the shared cache.

Example 25 includes the substance of the exemplary non-transitory machine-readable medium of Example 24, wherein the operations further comprise: evicting, following performance of the four-hop data transfer process, the cache line from the shared cache; and setting the consumer field of the tag entry associated with the cache line to zero in response to evicting the cache line from the shared cache.

Example 26 includes the substance of the exemplary non-transitory machine-readable medium of any one of Examples 21-25, wherein the operations further comprise: determining, by the shared cache in response to receipt of the first request, which is a read request for the cache line, whether the cache line is allocated in the shared cache; and performing, by the shared cache and the first core cache, a two-hop data transfer process in response to determining that the cache line is allocated in the shared cache, wherein the two-hop data transfer process includes transferring the cache line from the shared cache to the first core cache.

Example 27 includes the substance of the exemplary non-transitory machine-readable medium of any one of Examples 21-26, wherein the first core cache is dedicated to a first core in the multi-core processor, the second core cache is dedicated to a second core in the multi-core processor, and the shared cache is shared between the first core and the second core.

Example 28 provides a system for managing a multi-level cache, the system comprising: a first core; a second core; a first core cache dedicated to the first core; a second core cache dedicated to the second core; a shared cache that is shared between the first core and the second core; and cache circuitry within one or more of the first core cache, the second core cache, and the shared core cache, the cache circuitry to: determine in response to receipt of a request for a cache line from the first core cache, whether the cache line is a widely-shared cache line or a single-producer-single-consumer cache line, and perform a three-hop data transfer process between the first core cache and the second core cache in response to determining that the cache line is a single-producer-single-consumer cache line, wherein the three-hop data transfer process transfers the cache line directly from the second core cache to the first core cache.

Example 29 includes the substance of the exemplary system of Example 28, wherein the cache circuitry determines whether the cache line is a widely-shared cache line or a single-producer-single-consumer cache line by comparing a consumer field of a tag entry associated with the cache line to a widely-shared threshold.

Example 30 includes the substance of the exemplary system of 29, wherein the tag entry is stored in a tag directory of the shared cache, wherein the tag directory tracks locations of cache lines in the first core cache, the second core cache, and the shared cache.

Example 31 includes the substance of the exemplary system of any one of Examples 29 and 30, wherein the cache circuitry is further to: increment the consumer field of the tag entry associated with the cache line in response to receiving the request when the first request is a read request for the cache line.

Example 32 includes the substance of the exemplary system of any one of Examples 28-31, wherein the cache circuitry is further to: perform a four-hop data transfer process in response to determining that the cache line is a widely shared cache line, wherein the four-hop data transfer process allocates the cache line in the shared cache from the second core cache and transmits the cache line from the shared cache to the first core cache line after the cache line is allocated in the shared cache.

Example 33 includes the substance of the exemplary system of Example 32, wherein the cache circuitry is further to: evict, following performance of the four-hop data transfer process, the cache line from the shared cache; and set the consumer field of the tag entry associated with the cache line to zero in response to evicting the cache line from the shared cache.

Example 34 includes the substance of the exemplary system of any one of Examples 28-33, wherein the cache circuitry is further to: determine, in response to receipt of the first request, which is a read request for the cache line, whether the cache line is allocated in the shared cache; and perform a two-hop data transfer process between the shared cache and the first core cache in response to determining that the cache line is allocated in the shared cache, wherein the two-hop data transfer process includes transferring the cache line from the shared cache to the first core cache.

Example 35 includes the substance of the exemplary system of any one of Examples 28-34, wherein the shared cache is at a first level of a multi-level cache system and the first core cache and the second core cache are at a second level of the multi-level cache.

Example 36 includes the substance of the exemplary system of any one of Examples 28-35, wherein the shared cache is at a first level of a multi-level cache system and the first core cache and the second core cache are at a second level of the multi-level cache.

Example 37 provides a system for adaptively performing a set of data transfer processes in a multi-core processor, the method comprising: a means for receiving, by a shared cache from a first core cache, a first request for a cache line; a means for determining, by the shared cache in response to receipt of the first request, whether the cache line is a widely-shared cache line or a single-producer-single-consumer cache line; and a means for performing, by the first core cache and a second core cache, a three-hop data transfer process in response to determining that the cache line is a single-producer-single-consumer cache line, wherein the three-hop data transfer process transfers the cache line directly from the second core cache to the first core cache.

Example 38 includes the substance of the exemplary system of Example 37, wherein the means for determining whether the cache line is a widely-shared cache line or a single-producer-single-consumer cache line comprises: a means comparing a consumer field of a tag entry associated with the cache line to a widely-shared threshold.

Example 39 includes the substance of the exemplary system of Example 38, wherein the tag entry is stored in a tag directory of the shared cache, wherein the tag directory tracks locations of cache lines in the first core cache, the second core cache, and the shared cache.

Example 40 includes the substance of the exemplary system of any one of Examples 38 and 39, further comprising: a means for incrementing the consumer field of the tag entry associated with the cache line in response to receiving the first request when the first request is a read request for the cache line.

Example 41 includes the substance of the exemplary system of any one of Examples 37-40, further comprising: a means for performing a four-hop data transfer process in response to determining that the cache line is a widely shared cache line, wherein the four-hop data transfer process allocates the cache line in the shared cache from the second core cache and transmits the cache line from the shared cache to the first core cache line after the cache line is allocated in the shared cache.

Example 42 includes the substance of the exemplary system of Example 41, further comprising: a means for evicting, following performance of the four-hop data transfer process, the cache line from the shared cache; and a means for setting the consumer field of the tag entry associated with the cache line to zero in response to evicting the cache line from the shared cache.

Example 43 includes the substance of the exemplary system of any one of Examples 37-42, further comprising: a means for determining, by the shared cache in response to receipt of the first request, which is a read request for the cache line, whether the cache line is allocated in the shared cache; and a means for performing, by the shared cache and the first core cache, a two-hop data transfer process in response to determining that the cache line is allocated in the shared cache, wherein the two-hop data transfer process includes transferring the cache line from the shared cache to the first core cache.

Example 44 includes the substance of the exemplary system of any one of Examples 37-43, wherein the first core cache is dedicated to a first core in the multi-core processor, the second core cache is dedicated to a second core in the multi-core processor, and the shared cache is shared between the first core and the second core.

Example 45 includes the substance of the exemplary system of any one of Examples 37-44, wherein the shared cache is at a first level of a multi-level cache system and the first core cache and the second core cache are at a second level of the multi-level cache system.

Example 46 includes the substance of the exemplary system of any one of Examples 37-45, wherein the shared cache is a Level 1 cache of the multi-core processor and the first core cache and the second core cache are each Level 2 caches of the multi-core processor.

1. A method for adaptively performing a set of data transfer processes in a multi-core processor, the method comprising:
receiving, by a shared cache from a first core cache, a first request for a cache line;
determining, by the shared cache in response to receipt of the first request, whether the cache line is a widely-shared cache line or a single-producer-single-consumer cache line; and
performing, by the first core cache and a second core cache, a three-hop data transfer process in response to determining that the cache line is a single-producer-single-consumer cache line,
wherein the three-hop data transfer process transfers the cache line directly from the second core cache to the first core cache.

2. The method of claim 1, wherein determining whether the cache line is a widely-shared cache line or a single-producer-single-consumer cache line comprises:
comparing a consumer field of a tag entry associated with the cache line to a widely-shared threshold.

3. The method of claim 2, further comprising:
incrementing the consumer field of the tag entry associated with the cache line in response to receiving the first request when the first request is a read request for the cache line.

4. The method of claim 3, further comprising:
performing a four-hop data transfer process in response to determining that the cache line is a widely shared cache line,
wherein the four-hop data transfer process allocates the cache line in the shared cache from the second core cache and transmits the cache line from the shared cache to the first core cache line after the cache line is allocated in the shared cache.

5. The method of claim 4, further comprising:
evicting, following performance of the four-hop data transfer process, the cache line from the shared cache; and
setting the consumer field of the tag entry associated with the cache line to zero in response to evicting the cache line from the shared cache.

6. The method of claim 1, further comprising:
determining, by the shared cache in response to receipt of the first request, which is a read request for the cache line, whether the cache line is allocated in the shared cache; and
performing, by the shared cache and the first core cache, a two-hop data transfer process in response to determining that the cache line is allocated in the shared cache,
wherein the two-hop data transfer process includes transferring the cache line from the shared cache to the first core cache.

7. The method of claim 1, wherein the first core cache is dedicated to a first core in the multi-core processor, the second core cache is dedicated to a second core in the multi-core processor, and the shared cache is shared between the first core and the second core.

8. A processor for managing a multi-level cache system, the processor comprising:
a first core;
a second core;
a first core cache dedicated to the first core;
a second core cache dedicated to the second core;
a shared cache that is shared between the first core and the second core; and
cache circuitry within one or more of the first core cache, the second core cache, and the shared core cache, the cache circuitry to:
determine in response to receipt of a request for a cache line from the first core cache, whether the cache line is a widely-shared cache line or a single-producer-single-consumer cache line, and
perform a three-hop data transfer process between the first core cache and the second core cache in response to determining that the cache line is a single-producer-single-consumer cache line,
wherein the three-hop data transfer process transfers the cache line directly from the second core cache to the first core cache.

9. The processor of claim 8, wherein the cache circuitry determines whether the cache line is a widely-shared cache line or a single-producer-single-consumer cache line by comparing a consumer field of a tag entry associated with the cache line to a widely-shared threshold.

10. The processor of claim 9, wherein the cache circuitry is further to:
increment the consumer field of the tag entry associated with the cache line in response to receiving the request when the first request is a read request for the cache line.

11. The processor of claim 10, wherein the cache circuitry is further to:
perform a four-hop data transfer process in response to determining that the cache line is a widely shared cache line,
wherein the four-hop data transfer process allocates the cache line in the shared cache from the second core cache and transmits the cache line from the shared cache to the first core cache line after the cache line is allocated in the shared cache.

12. The processor of claim 11, wherein the cache circuitry is further to:
evict, following performance of the four-hop data transfer process, the cache line from the shared cache; and
set the consumer field of the tag entry associated with the cache line to zero in response to evicting the cache line from the shared cache.

13. The processor of claim 8, wherein the cache circuitry is further to:
determine, in response to receipt of the first request, which is a read request for the cache line, whether the cache line is allocated in the shared cache; and
perform a two-hop data transfer process between the shared cache and the first core cache in response to determining that the cache line is allocated in the shared cache,
wherein the two-hop data transfer process includes transferring the cache line from the shared cache to the first core cache.

14. A non-transitory machine-readable medium containing instructions that, when performed by a processor, cause the performance of operations comprising:
receiving, by a shared cache from a first core cache, a first request for a cache line;
determining, by the shared cache in response to receipt of the first request, whether the cache line is a widely-shared cache line or a single-producer-single-consumer cache line; and
performing, by the first core cache and a second core cache, a three-hop data transfer process in response to determining that the cache line is a single-producer-single-consumer cache line,
wherein the three-hop data transfer process transfers the cache line directly from the second core cache to the first core cache.

15. The non-transitory machine-readable medium of claim 14, wherein determining whether the cache line is a widely-shared cache line or a single-producer-single-consumer cache line comprises:
comparing a consumer field of a tag entry associated with the cache line to a widely-shared threshold.

16. The non-transitory machine-readable medium of claim 15, wherein the operations further comprise:
incrementing the consumer field of the tag entry associated with the cache line in response to receiving the first request when the first request is a read request for the cache line.

17. The non-transitory machine-readable medium of claim 16, wherein the operations further comprise:
performing a four-hop data transfer process in response to determining that the cache line is a widely shared cache line,
wherein the four-hop data transfer process allocates the cache line in the shared cache from the second core cache and transmits the cache line from the shared cache to the first core cache line after the cache line is allocated in the shared cache.

18. The non-transitory machine-readable medium of claim 17, wherein the operations further comprise:
evicting, following performance of the four-hop data transfer process, the cache line from the shared cache; and
setting the consumer field of the tag entry associated with the cache line to zero in response to evicting the cache line from the shared cache.

19. The non-transitory machine-readable medium of claim 14, wherein the operations further comprise:
determining, by the shared cache in response to receipt of the first request, which is a read request for the cache line, whether the cache line is allocated in the shared cache; and
performing, by the shared cache and the first core cache, a two-hop data transfer process in response to determining that the cache line is allocated in the shared cache,
wherein the two-hop data transfer process includes transferring the cache line from the shared cache to the first core cache.

20. The non-transitory machine-readable medium of claim 14, wherein the first core cache is dedicated to a first core in the multi-core processor, the second core cache is dedicated to a second core in the multi-core processor, and the shared cache is shared between the first core and the second core.
